(19) United States
(12) Patent Application Publication
(10) Pub. No.: US 2009/0008582 A1
(43) Pub. Date: Jan. 8, 2009

(54) VALVE ELEMENT

(76) Inventors: Rebecca S. Reuhs, Willowbrook, IL (US); Richard T. Miller, Worth, IL (US)

Correspondence Address: THE CLOROX COMPANY, P.O. BOX 24305, OAKLAND, CA, 94623-1305, US

(21) Appl. No.: 12/160,300

(22) PCT Filed: Jan. 22, 2007
(86) PCT No.: PCT/US2007/060831

§ 371 Date: Jul. 8, 2008

Related U.S. Application Data
(60) Provisional application No. 60/762,804, filed on Jan. 27, 2006.

(51) Int. Cl. F16K 31/00

(52) U.S. Cl. 251/61.1; 383/42

(57) ABSTRACT

The valve element for attachment to a flexible bag may include one or more flexible layers intended to extend over a hole disposed through a sidewall of the bag. In its normal condition, the layer or layers are in adjacent contact to each other or to the bag sidewall and thereby cover and seal the hole. During evacuation, the layer or layers displace to provide a collapsible and expandable channel that allows air to move from the hole to an exit point. To facilitate sealing of the valve element, a tacky surface is included in the valve element. The tacky surface can have a tackiness quality that normally holds the layers and/or sidewall together but that can be overcome during evacuation to expand the channel.

### FIELD OF THE INVENTION

The invention relates generally to valve elements and more particularly to one-way valve elements adapted for use with air and similar gasses. The invention finds particular applicability in the field of flexible storage bags used for storing food items.

### BACKGROUND OF THE INVENTION

One type of one-way valve element commonly used with containers to store coffee beans is a generally planar structure constructed from two or more plies or layers of flexible, thermoplastic film. A first layer or base layer has an aperture and the second layer or top layer is joined to the base layer to normally cover the aperture. During evacuation, air is moved through the aperture and displaces the flexible top layer with respect to base layer thereby allowing the evacuating air to escape to the environment. After evacuation, the resilient top layer returns to its normal position overlying and covering the aperture. To assist in sealing the aperture, the valve element may include silicone oil applied between the layers. Because of its liquid-like properties, silicone oil may leak from the valve element to an adjacent surface.

### BRIEF SUMMARY OF THE INVENTION

The invention provides a novel one-way valve element that can be used for evacuating flexible storage bags. The invention also provides a flexible storage bag that employs the novel valve element. The one-way valve element according to the invention can be made from one or more plies or layers of flexible material that operate to control air flow. In use, the layer or layers are attached to a flexible sidewall so as to cover a hole disposed through the sidewall which establishes communication between the valve element and the interior volume. The layers are normally adjacent the sidewall so as to cover the hole. During evacuation, air from the interior volume passes through the hole and thus displaces the layer or layers with respect to the bag sidewall and thereby allows the air to escape from the bag.

To assist in forming a seal when the valve element is in its normally closed position, the valve element can include a tacky surface that causes the layer or layers adhere to each other and/or to the bag sidewall. The tacky surface may facilitate sealing of the valve element while still allowing the layer or layers to displace during evacuation. In various embodiments, the tacky surface may be created by applying an adhesive to one or more layers, by mixing a material into one or more layers, or by treating the surface of one or more layers.

The tacky surface may be less susceptible to displacement within the valve element or leaking from the valve element during evacuation. These and other advantages and features of the invention will become apparent from the detailed description and the accompanying drawings.

### BRIEF DESCRIPTION OF THE DRAWINGS

FIG. 1 is a perspective view of a flexible bag having attached to the sidewall and communicating with the interior volume a one-way valve element designed in accordance with the teachings of the invention.

FIG. 2 is an exploded view of the one-way valve element of FIG. 1 illustrated in relationship to the flexible bag.

FIG. 3 is a cross-sectional view of the one-way valve element taken along line A-A of FIG. 1 and illustrating the channel in the normally collapsed configuration.

FIG. 4 is a cross-sectional view of the one-way valve element taken along line A-A of FIG. 1 and illustrating the channel in the expanded configuration.

FIG. 5 is an exploded view of another embodiment of a valve element.

FIG. 6 is a cross-sectional view of the valve element of FIG. 5 and illustrating the channel in the normally collapsed configuration.

FIG. 7 is a cross-sectional view of the valve element of FIG. 5 and illustrating the channel in the expanded configuration.

FIG. 8 is a perspective view of another embodiment of a valve element.

FIG. 9 is a perspective view of the opposite side of the valve element shown in FIG. 8.

FIG. 10 is a cross-sectional view of the valve element taken along line 10-10 of FIG. 8.

### DETAILED DESCRIPTION OF THE EMBODIMENTS

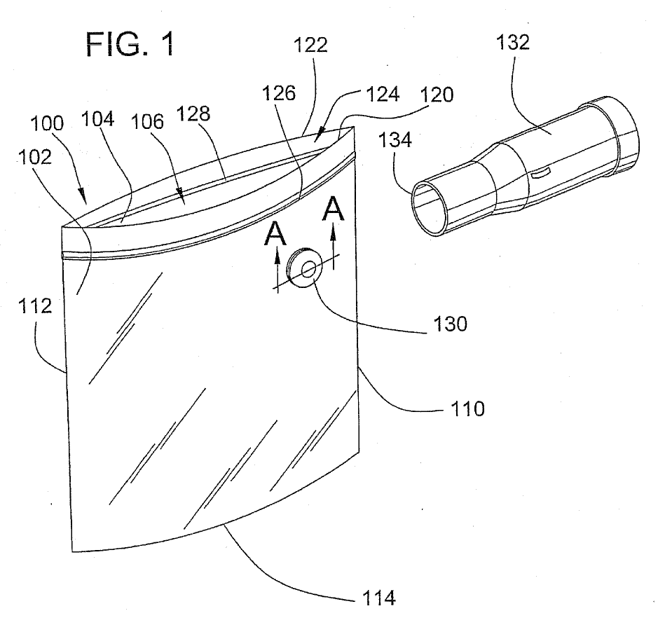

Referring to FIG. 1, a storage bag 100 for storing items such as food stuffs is illustrated. In the illustrated embodiment, the storage bag 100 is made from a first sidewall 102 and an opposing second sidewall 104 overlying the first side wall to provide an interior volume 106 therebetween. The first and second sidewalls 102, 104 are joined along a first side edge 110, a parallel or non-parallel second side edge 112, and a closed bottom edge 114 that extends between the first and second side edges. The first and/or second sidewalls 102, 104 may be made from a flexible or pliable thermoplastic material formed or drawn into a thin walled sheet. Examples of suitable thermoplastic materials include high density polyethylene (HDPE), low density polyethylene (LDPE), polypropylene (PP), ethylene vinyl acetate (EVA), nylon, polyester, polyamide, ethylene vinyl alcohol, and can be formed in single or multiple layers. The thermoplastic material can be transparent, translucent, opaque, or tinted. Furthermore, the material used for the sidewalls can be a gas impermeable material. The sidewalls 102, 104 can be joined along the first and second side edges 110, 112 and bottom edge 114 by any suitable process such as, for example, heat sealing.

For accessing the interior volume 106, the top edges 120, 122 of the first and second sidewalls 102, 104 remain un-joined to define an opening 124. To seal the opening 124, first and second interlocking fastening strips 126, 128 can be attached to the interior surfaces of the respective first and second sidewalls 102, 104. The first and second fastening strips 126, 128 extend generally between the first and second side edges 110, 112 parallel to and spaced below the top edges 120, 122. In other embodiments, the bag 100 can include a movable slider straddling the fastening strips 126, 128 to facilitate occluding and deoccluding of the opening 124.

To evacuate the storage bag 100 of latent or entrapped air after the opening has been closed, a one-way valve element 130 designed in accordance with the teachings of the invention is provided. The valve element 130 is attached to the first flexible sidewall 102 and communicates with the interior volume 106. In one embodiment, the one-way valve element 130 is configured to open under an applied pressure differential thereby allowing air from the interior volume 106 to escape and to close after elimination or reduction of the pressure differential thereby preventing the ingress of environmental air into the interior volume. To establish the pressure differential, a vacuum device can be used. For example, as illustrated in FIG. 1, the vacuum device 132 is configured as a hand-held, electrically operated device having a nozzle 134. When activated, the vacuum device draws air from the interior volume 106 through the valve element 130. In other embodiments, the pressure differential can be provided by applying a compressive force to the flexible sidewalls 102, 104 thereby forcing air from the internal volume through the valve element.

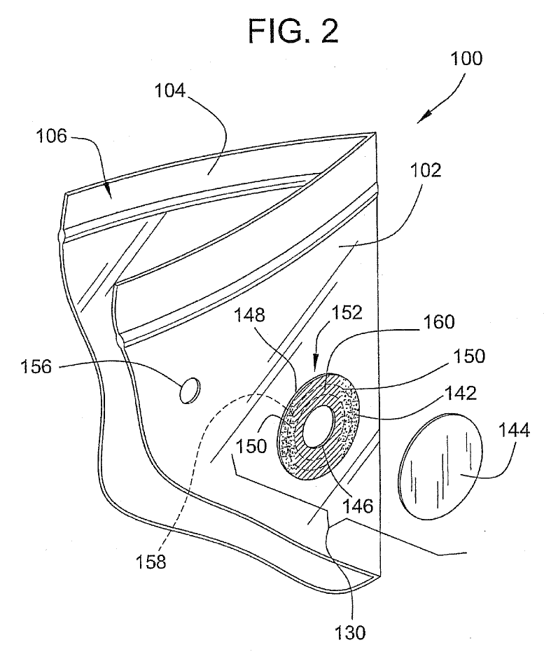

Referring to FIG. 2, the multi-ply valve element 130 includes a base layer 142 and a corresponding top layer 144. The base layer and top layer can be made from any suitable material such as, for example, a flexible, transparent, thermoplastic film. Additionally, the base layer and the top layer can be made from the same or different materials. Examples of suitable materials include high density polyethylene (HDPE), low density polyethylene (LDPE), ethylene vinyl acetate (EVA), polypropylene and blends thereof. The base layer 142 is circular with an aperture 146 disposed through its center such that the base layer appears annular in shape. The top layer 144 is positioned over and secured to the base layer 142 so as to extend over the aperture 146. Moreover, the top layer 144 also corresponds in size and shape to the base layer 142 such that the two layers provide a circular periphery 148 for the valve element. The valve element can have any suitable size; for example, the valve element can have a diameter of ½ inch to 1 inch. The aperture can also have any suitable size; for example, the valve element can have a diameter of ¼ inch to ½ inch. Of course, it will be readily recognized that in other embodiments the valve element can have any other suitable size or shape including any of various polygonal shapes.

To secure the top layer 144 to the base layer 142, in the embodiment illustrated in FIG. 2, two parallel strips of adhesive 150 are applied to the base layer extending along either side of the aperture 146. The portions of the top and base layers 142, 144 located between the two adhesive strips 150 correspond to an expandable and collapsible channel 152 that extends from the aperture 146 to opposing exit points at the periphery 148 of the valve element 130. The valve element 130 is then adhered by a ring of adhesive 158 (indicated by phantom lines on the underside of the base layer 142) to the flexible bag 100 so as to extend over the hole 156 disposed through the first sidewall 102. Once attached, the aperture 146 should align with the hole 156. In other embodiments, other suitable joining methods besides or in addition to adhesive can be employed to secure together the base and top layers, and the base layer to the sidewall, for instance, heat sealing. In yet other embodiments, the hole 156 may be a single slit 457, such as shown in FIG. 11, two or more slits 557, 559, such as shown in FIG. 12 or two or more slits 657, 659 which intersect such as shown in FIG. 13. The slit or slits may not require the removal of material during the manufacturing process. Thus, the speed of the process may be maintained versus a possible reduction in speed if the material is removed.

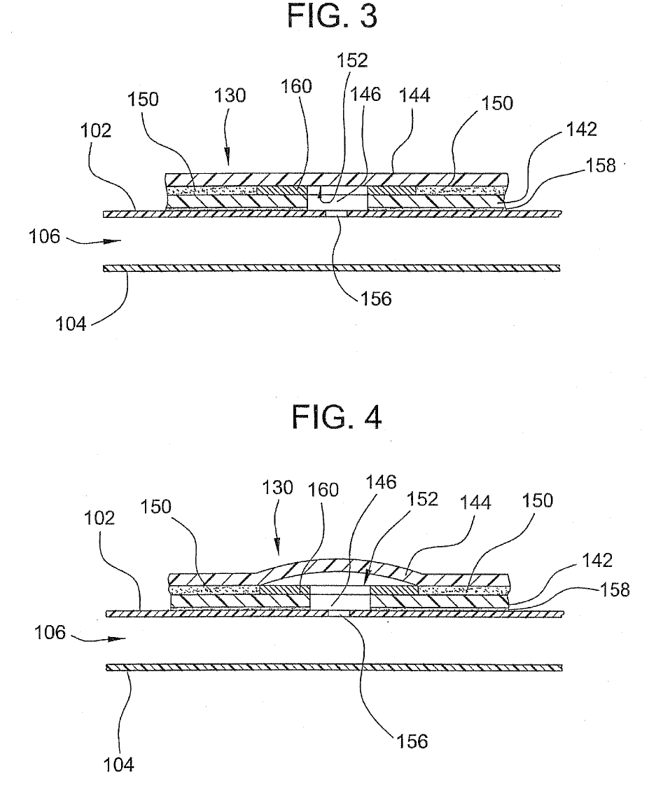

Referring to FIG. 3, to prevent air from the environment from entering into the interior volume 106, the channel 152 is normally in a collapsed condition with the top layer covering the aperture 146. During evacuation, air from the internal volume 106 will pass through the hole 156 in the first sidewall 102 and through the aperture 146 in the base layer 142. This evacuating air partially displaces the top layer 144 from the base layer 142 and thereby places the channel 152 into the expanded condition illustrated in FIG. 4. The air can then pass along the expanded channel 152 formed between the adhesive strips 150 to the periphery of the valve element and escapes to the environment. Once evacuation is completed, the resilient top layer 144 will return to its prior configuration covering and sealing the aperture 146 and thereby collapsing the channel 152.

In accordance with the invention, to facilitate the functioning of the valve element, a tacky surface may be located on the base layer, the top layer or both layers. More particularly, referring to FIG. 2, the tacky surface 160 can be located between the parallel strips of adhesive 150 that correspond to the expandable and collapsible channel. Furthermore, the tacky surface 160 may extend continuously from proximate the aperture 146 to the exit points at the periphery 148 of the valve element. In other embodiments, the tacky surface may be non-continuous.

The tacky surface may be created by applying an adhesive to one or more layers, by mixing a material into one or more layers or by treating the surface of one or more layers.

With respect to applying an adhesive to one or more layers, the adhesive may be a pressure sensitive adhesive, a hot melt adhesive, an ultraviolet cured adhesive or a water based adhesive.

With respect to mixing material into one or more layers, the material may be a soft resin or a tackifying agent. Examples of a soft resin may include amorphous polypropylene, amorphous polyethylene, ethylene vinyl acetate, ethylene methyl acrylate, or ultra low molecular weight polyethylene. Examples of a tackifying agent may be glycerol monoleate, polybutene (Isobutylene/butane copolymers), terpene phenolic resin, metallic stearates, rosin resin, hydrocarbon resin, or SIS copolymers (styrene-isoprene-styrene).

With respect to treating the surface of one or more layers, the surface treatment may create a chemically activated surface with an increased surface energy. Thus, the surface may be more ready to accept an item that may come into contact with the surface. The surface treatment may be corona treating, static charge treating or plasma treating. For example, the corona treating creates a tacky surface by exposing the surface to an electrical discharge or corona. The oxygen molecules within the discharge area break into their atomic form and are free to bond to the ends of the molecules in the material being treated which results in a chemically activated surface.

The tacky surface may demonstrate a tackiness quality that helps hold the top layer 142 in adjacent contact with the base layer 144 when the channel is in the collapsed position thereby covering the aperture. For example, the tackiness qualities of the tacky surface can be measured by peel strength or the amount of force required to separate the base and top layers in order to expand the channel during evacuation. The peel strength can be strong enough to normally hold the layers together under normal conditions but not so strong as to prevent the channel from opening during evacuation.

Referring to FIG. 3, when the channel is in the normally collapsed position, the top layer 144 is sealingly held adjacent to the base layer 142 by the tacky surface 160. Thus, as will be appreciated from FIG. 3, the presence of the tacky surface 160 helps maintain the valve element in the closed configuration sealing the internal volume 106. During evacuation, as illustrated in FIG. 4, air passing through hole 156 displaces the flexible top layer 144 with respect to the tacky surface 160 as well as with respect to the base layer 142 thereby providing the expanded channel 152 allowing air to escape. To facilitate functioning of the valve element 130, the adhesive strips 150 used to join the top layer 144 and base layer 142 can have a stronger peel strength than the tacky surface 160 such that only the top and base layers separate in the region corresponding to the channel 152.

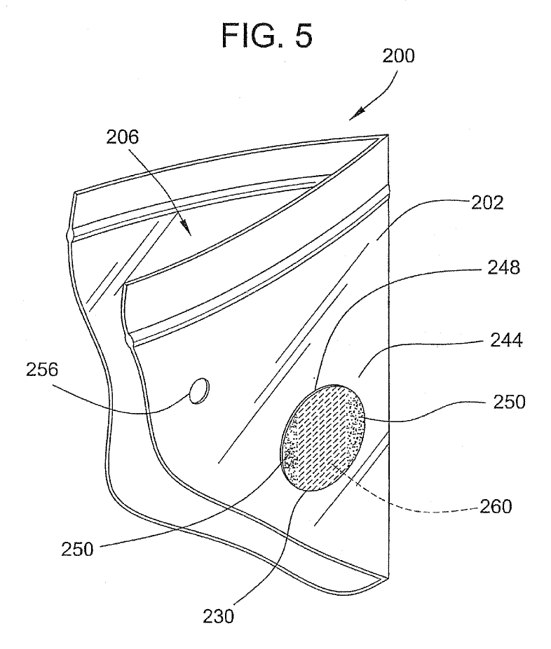

In another embodiment, the tacky surface may be used in a flexible one way valve that consists of only a single flexible layer applied over the aperture in the sidewall. FIG. 5 shows one embodiment of a valve element 230 having a single layer 244 applied over the aperture 256 disposed through a sidewall 202 of the bag 200. The valve element 230 does not have a base layer. To join the single layer 244 to the sidewall 202, two parallel strips of adhesive 250 may be applied to the single layer. In other embodiments, other suitable joining methods besides or in addition to adhesive can be employed to secure the layer to the sidewall, for instance, heat sealing.

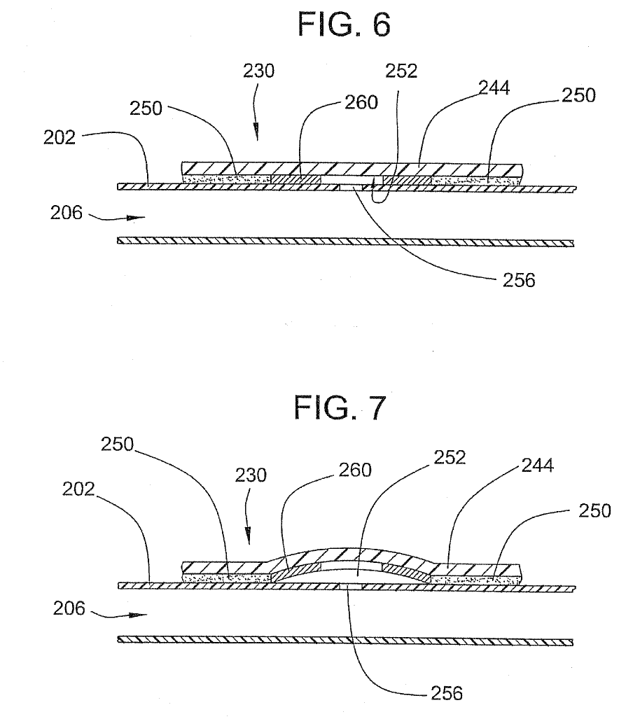

Referring to FIG. 6, to prevent air from the environment from entering into the interior volume 206, the valve element 230 including the channel 252 is normally in a collapsed condition with the single layer 244 covering the aperture 256. Referring to FIG. 7, during evacuation, air from the internal volume 206 will pass through the hole 256 in the first sidewall 202. This evacuating air partially displaces the single layer 244 from the sidewall 202 and thereby places the channel 252 into the expanded condition. The air can then pass along the expanded channel 252 formed between the adhesive strips 250 to the periphery of the valve element 230 and escape to the environment. Once evacuation is completed the resilient single layer 244 will return to its prior configuration covering and sealing the aperture 256 and thereby collapsing the channel 252.

In accordance with the invention, to facilitate the functioning of the valve element, a tacky surface may be located on the sidewall 202, the top layer 244 or both. More particularly, referring to FIG. 5, the tacky surface 260 may be located on the single layer 244 between the parallel strips of adhesive 250 so as to correspond to the location of the hole 256 disposed into the sidewall 202. Furthermore, the tacky surface 260 may extend from proximate the aperture 256 to the exit points at the periphery 248 of the layer 244. The tacky surface may be created as noted herein, such as, by applying an adhesive, by mixing in a material or by treating the surface.

Referring to FIG. 6, when the channel is in the normally collapsed position, the single layer 244 is held by the tacky surface 260 in adjacent contact with the sidewall 202. Thus, as will be appreciated from FIG. 6, the presence of the tacky surface 260 helps seal the hole 256 disposed through the first side wall 202. During evacuation, the force induced by air escaping through the hole 256 is sufficient to overcome the peel strength of the tacky surface 260 and displace the flexible top layer 244 with respect to the sidewall thereby providing the expanded channel 252. To facilitate functioning of the valve element 230, the adhesive strips 250 used to join the single layer 244 and the sidewall 202 can have a stronger peel strength than the tacky surface 260 such that only the top and base layers separate in the region corresponding to the channel 252. It should be appreciated that in other embodiments, the tacky surface 260 can be located on the sidewall 202. In yet other embodiments, the hole 256 may be a single slit. In yet other embodiments, the hole 256 may be a single slit 457, such as shown in FIG. 11, two or more slits 557, 559, such as shown in FIG. 12, or two or more slits 657, 659 which intersect such as shown in FIG. 13.

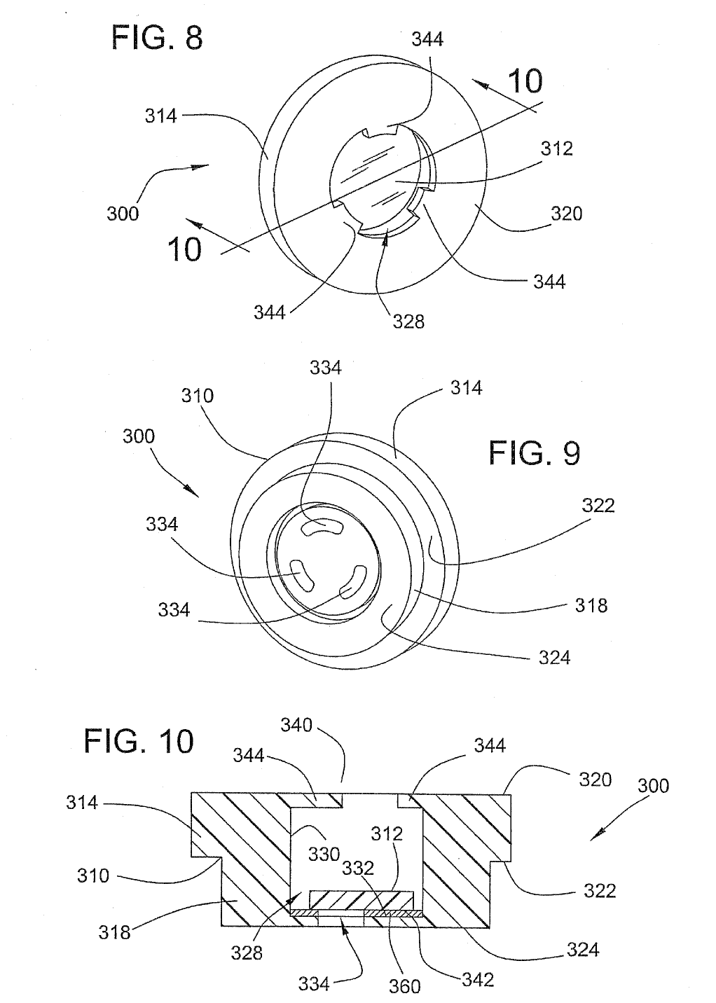

In an additional embodiment, the tacky surface may be used in a rigid one-way valve element. Referring to FIGS. 8, 9, and 10, the one-way valve element 300 for use with a storage bag of the foregoing type can include a rigid valve body 310 that cooperates with a movable disk 312 to open and close the valve element. The valve body 310 includes a circular flange portion 314 extending between parallel first and second flange faces 320, 322. Concentric to the flange portion 314 and projecting from the second flange face 322 is a circular boss portion 318 which terminates in a planar boss face 324 that is parallel to the first and second flange faces. The circular boss portion 318 is smaller in diameter than the flange portion 314 so that the outermost annular rim of the second flange face 322 remains exposed. The valve body 310 can be made from any suitable material such as a moldable thermoplastic material like nylon, HDPE, high impact polystyrene (HIPS), polycarbonates (PC), and the like.

Disposed concentrically into the valve body 310 is a counter-bore 328. The counter-bore 328 extends from the first flange face 320 part way towards the boss face 324. The counter-bore 328 defines a cylindrical bore wall 330. Because it extends only part way toward the boss face 324, the counter-bore 328 forms within the valve body 310 a preferably planar valve seat 332. To establish fluid communication across the valve body 310, there is disposed through the valve seat 332 at least one aperture 334. In fact, in the illustrated embodiment, a plurality of apertures 334 are arranged concentrically and spaced inwardly from the cylindrical bore wall 330.

To cooperatively accommodate the movable disk 312, the disk is inserted into the counter-bore 328. Accordingly, the disk 312 is preferably smaller in diameter than the counter-bore 328 and has a thickness as measured between a first disk face 340 and a second disk face 342 that is substantially less than the length of the counter-bore 328 between the first flange face 320 and the valve seat 332. To retain the disk 312 within the counter-bore 328, there is formed proximate to the first flange face 320 a plurality of radially inward extending fingers 344. The disk 312 can be made from any suitable material such as, for example, a resilient elastomer.

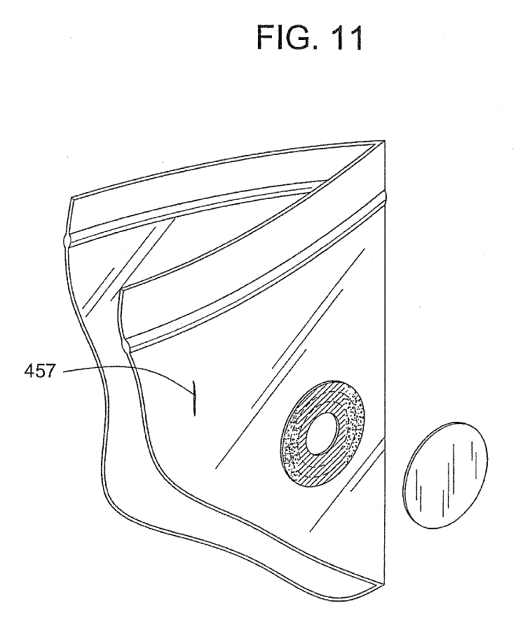

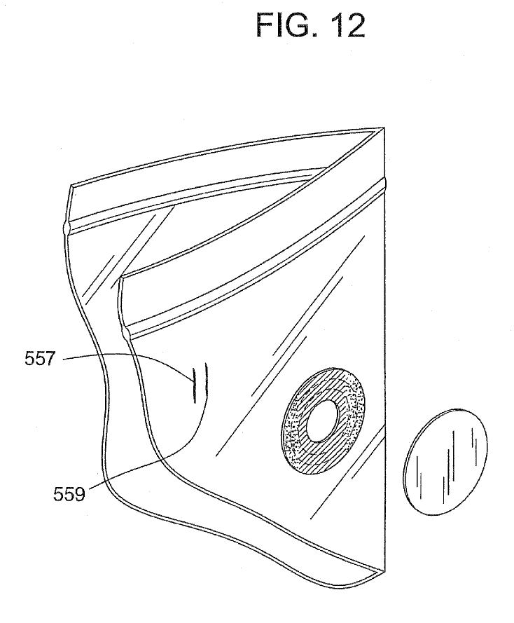

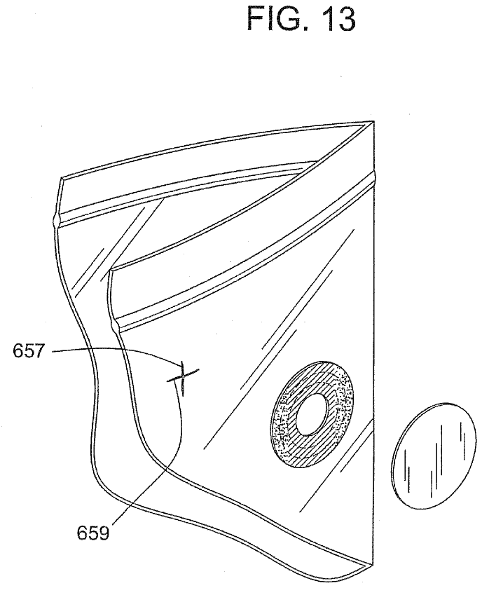

Referring to FIG. 10, when the disk 312 within the counter-bore 328 is moved adjacent to the fingers 344, the valve element 300 is in its open configuration allowing air to communicate between the first flange face 320 and the boss face 324. However, when the disk 312 is adjacent the valve seat 332 thereby covering the apertures 334, the valve element 300 is in its closed configuration. To assist in sealing the disk 312 over the apertures 334, a tacky surface 360 can be located on the valve seat 332. In other embodiments, the tacky surface 360 may be located on the disk 312, such as the disk face 342. The tacky surface may be created as noted herein, such as, by applying an adhesive, by mixing in a material or by treating the surface. The tacky surface 360 has a tackiness property that causes the valve disk 312 to be held adjacent the valve seat 332 so as to seal the apertures 334. The tackiness property, however, should not be so strong as to prevent the valve disk 312 from moving adjacent the fingers 344 during evacuation.

To attach the valve element 300 to the first sidewall, referring to FIG. 9, an adhesive can be applied to the exposed annular rim portion of the second flange face 322. The valve element 300 can then be placed adjacent the exterior surface of the first sidewall with the boss portion 318 being received through the hole disposed into the sidewall and thereby pass into the internal volume. In other embodiments, adhesive can be placed on other portions of the valve element, such as the first flange face, prior to attachment to the sidewall. In yet other embodiments, other suitable joining methods besides or in addition to adhesive can be employed to secure the valve element to the sidewall, for instance, heat sealing. Also, in other embodiments, the hole in the bag sidewall may be a slit or slits as noted herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor(s) for carrying out the invention. Variations of those preferred embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A one-way valve element comprising:
a base layer having an aperture disposed therein;
a top layer joined to the base layer and covering the aperture, the top layer and base layer being joined so as to provide an expandable and collapsible channel between the aperture and an exit point on the valve element; and
a tacky surface on one of the top layer and base layer.

2. The one-way valve element of claim 1, wherein the tacky surface is provided continuously throughout in the channel between the aperture and the exit point.

3. The one-way valve element of claim 1, wherein the tacky surface is created by mixing a material into one of the layers.

4. The one-way valve element of claim 1, wherein the tacky surface is created by applying an adhesive to one of the layers

5. The one-way valve element of claim 1, wherein the tacky surface is created by treating the surface of one of the layers.

6. The one-way valve element of claim 1, wherein the valve element including the base layer and the top layer are circular in shape.

7. The one-way valve element of claim 6, wherein the exit point is on the perimeter of the valve element.

8. The one-way valve element of claim 1, wherein the base layer and the top layer are joined by adhesive, the adhesive having a higher peel strength than the tacky surface.

9. The one-way valve element of claim 8, wherein the adhesive is applied in parallel first and second strips extending along either side of the aperture, the channel provided between the adhesive strips.

10. A storage bag comprising:
a first flexible sidewall;
a second flexible sidewall overlaying and joined to the first flexible sidewall to provide an interior volume;
a one-way valve element attached to the first sidewall and communicating with the internal volume, the one-way valve element including a base layer having an aperture disposed therein, the one-way valve element further including a top layer joined to the base layer and covering the aperture, the top layer and base layer being joined so as to provide an expandable and collapsible channel between the aperture and an exit point on the valve element, the valve element further including a tacky surface on one of the top layer and base layer.

11. The one-way valve element of claim 10, wherein the tacky surface is created by mixing a material into one of the layers.

12. The one-way valve element of claim 10, wherein the tacky surface is created by applying an adhesive to one of the layers.

13. The one-way valve element of claim 10, wherein the tacky surface is created by treating the surface of one of the layers.

14. A method of evacuating a storage bag comprising:
providing a bag including an interior volume, an opening for accessing the interior volume, a one-way valve element communicating with the interior volume, the valve element having a base layer and a top layer being joined so as to provide an expandable and collapsible channel;
closing the opening;
exhausting air from the interior volume to the environment via the expanded channel;
collapsing the channel; and
sealing the channel between the top layer and base layer with a tacky surface.

15. A storage bag comprising:
a first flexible sidewall including a hole disposed there-through;
a second flexible sidewall overlaying and joined to the first flexible sidewall to provide an interior volume;
a one-way valve element attached to the first sidewall and communicating with the internal volume, the one-way valve element including a flexible layer joined to the first sidewall so as to extend over the hole and to provide an expandable and collapsible channel between the hole and an exit point on the flexible layer, the valve element further including a tacky surface on one of the flexible layer and first sidewall.
